(19) United States
(12) Patent Application Publication
(10) Pub. No.: US 2022/0366377 A1
(43) Pub. Date: Nov. 17, 2022

(54) COMPUTER IMPLEMENTED TIME MANAGEMENT SYSTEM AND METHODS

(71) Applicant: Helio Silva, Lisboa (PT)

(72) Inventor: Helio Silva, Lisboa (PT)

(21) Appl. No.: 17/741,121

(22) Filed: May 10, 2022

Related U.S. Application Data
(60) Provisional application No. 63/186,875, filed on May 11, 2021.

(51) Int. Cl. G06Q 10/10; G06Q 40/06

(52) U.S. Cl. CPC G06Q 10/1097; G06Q 40/06

(57) ABSTRACT

A time management system may include: a client device having a display screen and an input interface for receiving input from a user; communication logic configured to receive user input, wherein the input comprises activity data and financial data; and management logic configured to generate To-Do tasks and Goals using the activity data and configured to generate financial transactions using the financial data, in which the Goals categories may include: Values, Vitality, Health, Growth, Finance, Career and Relationships. The user may query the communication engine to view, plan, and generate reports for the To-Do tasks and financial transactions on their client device, and the user may provide input to the communication engine for the generation of messages which may be sent to the client devices of one or more other users in which the message(s) may include data describing one or more of a To-Do task, Goal, and financial transaction of the user.

### CROSS REFERENCE TO RELATED APPLICATIONS

This application claims priority to and the benefit of the filing date of U.S. Provisional Application No. 63/186,875, filed on May 11, 2021, entitled “COMPUTER IMPLEMENTED TIME MANAGEMENT SYSTEM AND METHODS”, which is hereby incorporated by reference in its entirety.

### FIELD OF THE INVENTION

This patent specification relates to the field of computer implemented time management system and methods. More specifically, this patent specification relates to systems and methods that are configured to function as personal productivity tool, such as which may be used to organize day to day activities and finances of a user.

### BACKGROUND

Many individuals use time and scheduling applications in order to schedule events in their lives. These applications typically enable the creation and management of personal calendars. While these applications may be useful for scheduling, they are unable to allow the user to see and control how the items on their calendar affects various aspects of their life. For this reason, existing applications are unable to organize personal events according to categories describing various aspects of their life and are therefore unable to provide the user with clarity that enables them understand the primary objective of a particular scheduled event.

Therefore, a need exists for novel computer implemented time management systems and methods. A further need exists for novel systems and methods systems and methods that are configured to function as personal productivity tool, such as which may be used to organize day to day activities and finances of a user. Yet a further need exists for novel systems and methods which allows a user to organize personal events according to categories describing various aspects of their life and which are able to provide the user with clarity that enables them understand the primary objective of a particular scheduled event.

### BRIEF SUMMARY OF THE INVENTION

A computer implemented time management system and methods are provided. The system may be configured to function as a personal productivity tool, such as which may be used to organize day to day activities and finances of a user which the user may enter into the system as activity data and financial data via a client device. In preferred embodiments, the system may enable a user to view and plan the events and financial transactions on their client device that may be classified or categorized into one or more goals with the relationships between the goals used as a framework for the user's life. The system guides users in the planning/scheduling of To-Do tasks or activities, such that the user not only knows what is the To-Do task or activity, when and where it will happen but also the primary reason or goal of the To-Do task or activity. The system may prompt the user to select which aspect of life the To-Do task or activity belongs to. The aspect of life or goal that an activity may be categorized under preferably may include: Values, Vitality, Health, Growth, Finance, Career and Relationships. In this way, the system may enable a user to organize personal events, tasks, activities, etc., according to one or more of the goal categories resulting in more clarity by enabling the user to easily see and understand the primary objective or goal of a particular scheduled event.

In some embodiments, a time management system may include: a client device having a display screen and an input interface for receiving input from a user; a computing platform having a processor, a memory in communication with the processor, communication logic stored in the memory, executable by the processor and configured to receive input from the user, wherein the input comprises activity data and financial data; and management logic stored in the memory, executable by the processor and configured to generate To-Do tasks and Goals using the activity data and configured to generate financial transactions using the financial data, in which the To-Do tasks are categorized under Goals that may include: Values, Vitality, Health, Growth, Finance, Career and Relationships. The user may query the communication engine to view, plan, and generate reports for the To-Do tasks and financial transactions on their client device, and the user may provide input to the communication engine for the generation of one or more messages which may be sent to the client devices of one or more other users in which the message(s) may include data describing one or more of a To-Do task, Goal, and financial transaction of the user.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a time management system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating some exemplary applications of a time management system which may function as software rules engines according to various embodiments described herein.

FIG. 5 illustrates a block diagram of an example of a computer-implemented time management method for managing To-Do tasks according to various embodiments described herein.

FIG. 6 shows a block diagram of an example of a computer-implemented time management method for managing Goals according to various embodiments described herein.

FIG. 7 depicts a block diagram of an example of a computer-implemented time management method for managing financial data according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer implemented time management system and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

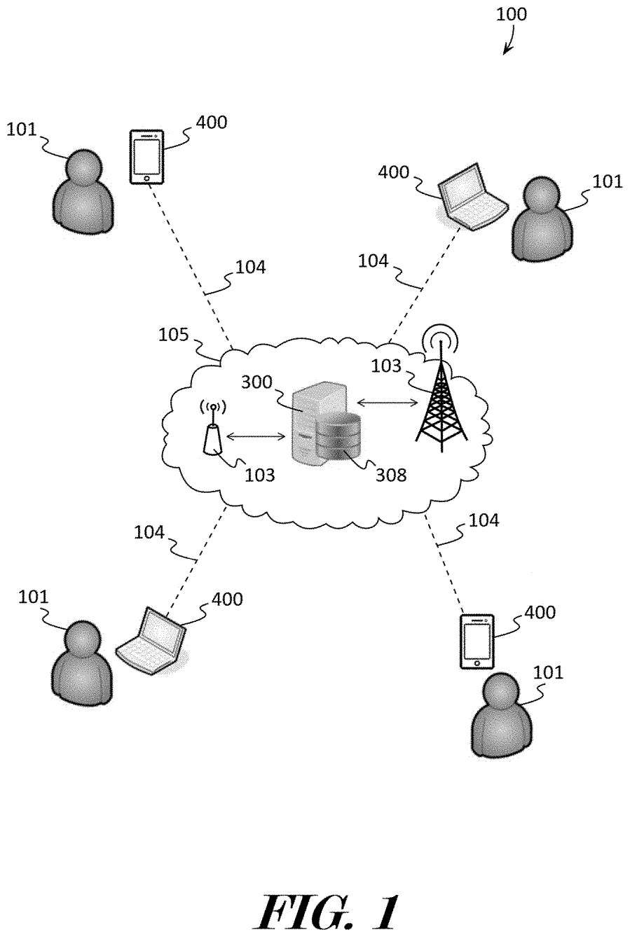

The present invention will now be described by example and through referencing the appended figures representing preferred and alternative embodiments. As perhaps best shown by FIG. 1, an illustrative example of some of the physical components which may comprise time management (“the system”) 100 according to some embodiments is presented. The system 100 is configured to facilitate the transfer of data and information between one or more access points 103, client devices 400, and servers 300 over a data network 105. A data store 308 accessible by the server 300 may contain one or more databases. Each client device 400 may send data to and receive data from the data network 105 through a network connection 104 with an access point 103. The data may comprise any information that one or more users 101 desire to input into the system 100 including information describing one or more users 101, information describing the actions of one or more users 101, information describing events scheduled for one or more users 101, information describing goals of one or more users 101, information describing financial transactions of one or more users 101, information describing to-do actions for one or more users 101, information describing inter-user 101 messaging for sharing financial transactions, goals, and to-do actions, information requested by one or more users 101, information supplied by one or more users 101, and any other information which a user 101 may desire to input or enter into the system 100.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

The system 100 may be configured to function as a personal productivity tool, such as which may be used to organize day to day activities, digital files, and finances of a user 101 which the user 101 may enter into the system 100 as activity data and financial data via a client device 400. In preferred embodiments, the system 100 may enable a user 101 to view and plan the events and financial transactions on their client device 400 that may be classified or categorized into one or more goals with the relationships between the goals used as a framework for the user's 101 life. The system 100 guides users 101 in the planning/scheduling of To-Do tasks or activities, such that the user 101 not only knows what is the To-Do task or activity, when and where it will happen but also the primary reason or goal of the To-Do task or activity. The system 100 may prompt the user 101 to select which aspect of life the To-Do task or activity belongs to. The aspect of life or goal that an activity may be categorized under may include: Values, Vitality, Health, Growth, Finance, Career and Relationships. In this way, the system 100 may enable a user 101 to organize personal events, tasks, digital files, activities, etc., according to one or more of the goal categories resulting in more clarity by enabling the user 101 to easily see and understand the primary objective or goal of a particular scheduled event.

In further embodiments, the scheduled data of the user 100 may be automatically organized by the system 100 into Goals and To-Do tasks so that the user 100 can statistically and categorically visualize Goals from To-Do tasks. Generally, Goals are the objectives and To-Do tasks refers to the actions to make the Goal happen. In still further embodiments, the system 100 allows the user 101 to record financial transaction data and enables a messaging capability between the client devices 400 of two or more users 101 which allows the users 101 to share financial transactions along with Goals and To-Do tasks.

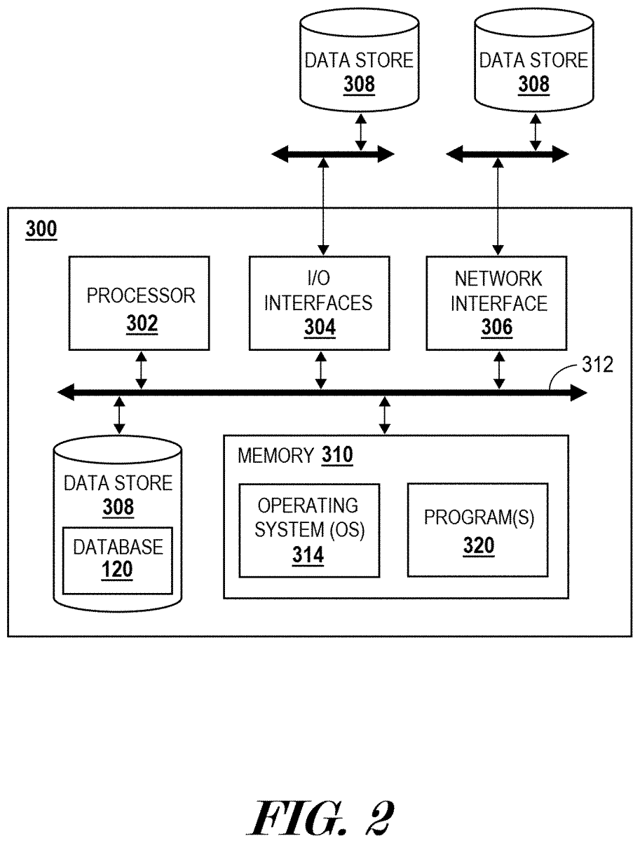

Referring now to FIG. 2, in an exemplary embodiment, a block diagram illustrates a server 300 of which one or more may be used in the system 100 or standalone. The server 300 may be a digital computer (computing device) that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network.

A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server. Preferably, the system 100 may comprise a system database 330 which may be stored in one or more data stores 308.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

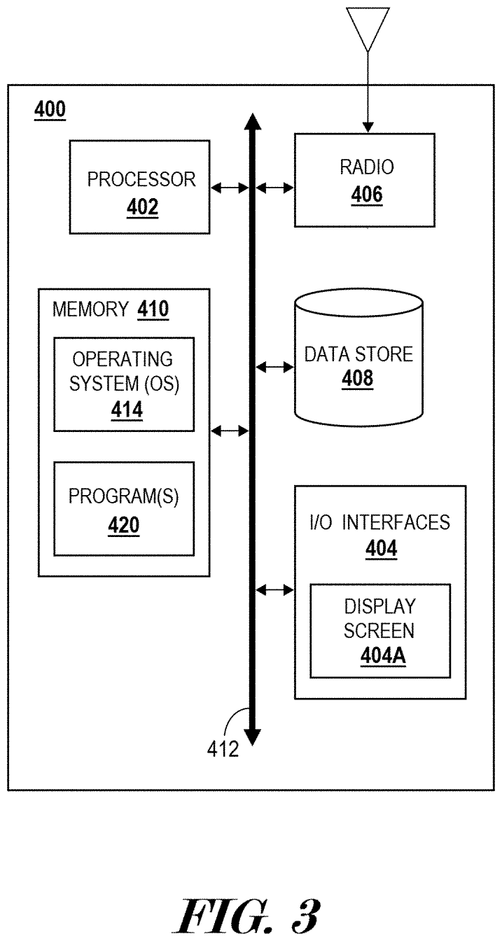

Referring to FIG. 3, in an exemplary embodiment, a block diagram illustrates a client device 400 of which one or more may be used in the system 100 or the like. The client device 400 can be a digital computing device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A such as a liquid crystal display (LCD), light emitting diode (LED) display, touch screen display, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); Z-Wave wireless communications protocol used primarily for home automation; IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to exchange information with the system 100.

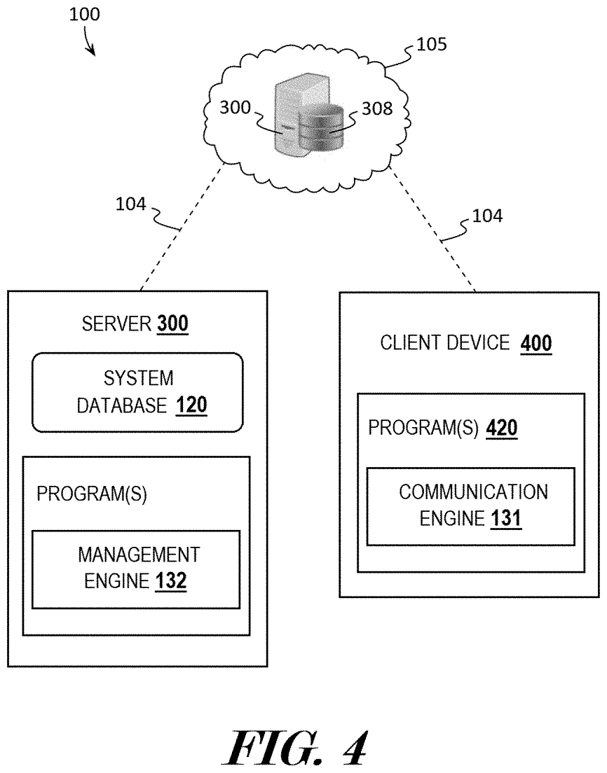

FIG. 4 depicts a block diagram showing some software rules engines which may be found in a system 100 and which may optionally be configured to run on a server 300 and/or a client device 400 according to various embodiments described herein. In some embodiments, one or more servers 300 may be configured to run one or more software rules engines or programs, such as a management engine 132, and one or more client devices 400 may be configured to run one or more software rules engines or programs, such as a communication engine 131. The server 300 may be in electronic communication with a data store 308 comprising a database, such as a system database 120. The engines 131, 132, may read, write, or otherwise access data in the system database 120 of the data store 308. Additionally, the engines 131, 132, may send and receive data to and from the one or more client devices 400 which may be in wired and/or wireless electronic communication with a server 300 through a network 105. It should be understood that the functions attributed to the engines 131, 132, described herein are exemplary in nature, and that in alternative embodiments, any function attributed to any engine 131, 132, may be performed by one or more other engines 131, 132, or any other suitable processor logic.

The system 100 may comprise a system database 120 stored on a data store 308 accessible to the management engine 132 and/or communication engine 131. In some embodiments, the system database 120 may comprise data and information that one or more users 101 desire to input into the system 100 including information describing one or more users 101, information describing the actions of one or more users 101, information describing events scheduled for one or more users 101, information describing Goals of one or more users 101, information describing financial transactions of one or more users 101, information describing To-do tasks or actions for one or more users 101, information describing inter-user 101 messaging for sharing financial transactions, goals, and to-do tasks, information requested by one or more users 101, information supplied by one or more users 101, and any other information which may be associated with a user 101 of the system 100.

The system 100 may comprise one or more communication engines 131. A communication engine 131 may comprise or function as communication logic stored in a memory 310, 410, which may be executable by the processor 302, 402, of a server 300 and/or client device 400. Generally, a communication engine 131 may be configured to operate an I/O interface 404, such as a display screen 404A (preferably of a touchscreen interface), of a client device 400 operated by a user 101 in order to output information to and receive information from the user 101. For example, a communication engine 131 may generate a graphic user interface (GUI) on the client device 400 of a user 101. In some embodiments, a communication engine 131 may be configured to enable data exchange between a client device 400 that is running the communication engine 131 and with a management engine 132 that may be running on a server 300. In further embodiments, a communication engine 131 may be configured to enable users 101 to send and receive messages which may contain data which may allow users 101 to share desired financial transactions, Goals, To-Do tasks, etc., with other users 101. In still further embodiments, a communication engine 131 may be configured to operate any of the I/O interfaces 404 of a client device 400 to allow the system 100 to input and output information from and to a user 101 via a client device 400.

The system 100 may comprise one or more management engines 132. A management engine 132 may comprise or function as management logic stored in a memory 310, 410, which may be executable by the processor 302, 402, of a server 300 and/or client device 400. In some embodiments, a management engine 132 may receive activity data input by a user 101, such as which may be input through a GUI on a client device 400, and automatically organize that data to generate Goals and To-Do tasks so that the user can statistically and categorically visualize Goals from To-Dos tasks. Goals are the objectives and To-Do tasks refers to the actions which need to be completed to make the Goal happen. For example, a To-Do task may comprise attending a continuing education class at a date and time which may be associated with the Goal related to Career category. As another example, a To-Do task may comprise paying a credit card bill on a certain date which may be associated with the Goal related to Finances category.

In further embodiments, a management engine 132 may receive financial data input by a user 101, such as which may be input through a GUI on a client device 400, and allow the user to associate the financial data which may describe one or more financial transactions of a user 101 with one or more Goals of the user 101. In further embodiments, a management engine 132 may receive financial data input by a user 101, such as which may be input through a GUI on a client device 400, and allow the user to share the financial data which may describe one or more financial transactions of a user 101 with one or more other users 101.

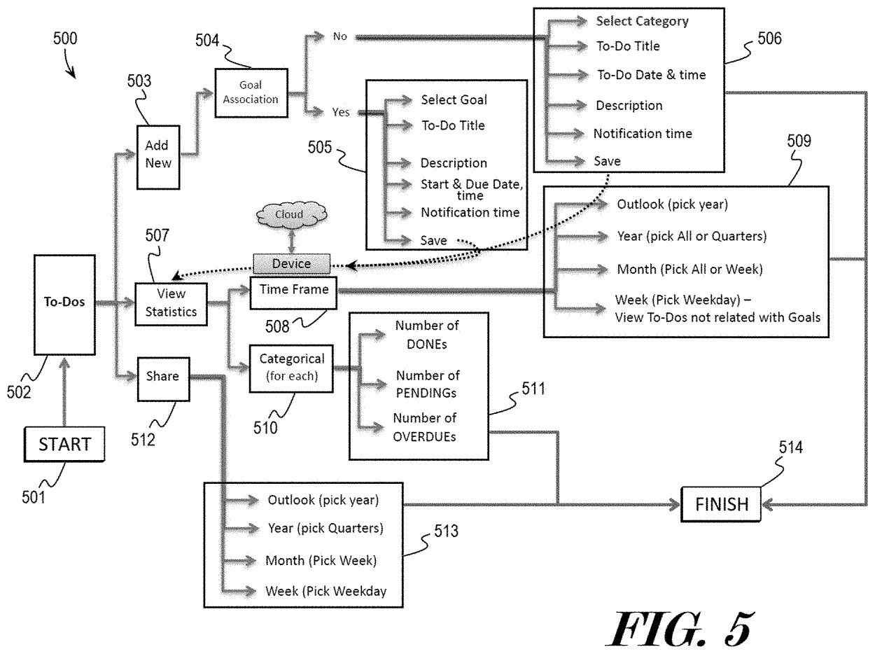

FIG. 5 shows a block diagram of an example of a computer-implemented time management method for managing To-Do tasks (“the method”) 500 according to various embodiments described herein. In some embodiments, the method 500 may be used to enable a user 101 to enter activity data into the system 100 which the system 100 may then generate To-Do tasks which may be associated with one or more Goals and display these to the user 101 via a GUI that may be generated on a client device 400 of the user 101 so that the user 101 can statistically and categorically visualize Goals from To-Do tasks. One or more steps of the method 500 may be performed by a communication engine 131 and/or a management engine 132 which may be executed by a computing device processor, such as a processor 302 (FIG. 2) and/or a processor 402 (FIG. 3).

In some embodiments, the method 500 may start 501 and a user 101 may interact with a GUI generated on their client device 400 by a communication engine 131 to provide input to the system 100 that indicates that the user 101 would like to access To-Do task data in step 502. The method 500 may then proceed to step 503, 507, or 512.

In step 503, the user 101 may enter To-Do task data which may be used by the management engine 132 to generate a new To-Do task. In step 504, the communication engine 131 may query the user 101 for data indicating that the user 101 wishes to associate the To-Do task with a Goal. If the user 101 provides input indicating that they do not want to associate the To-Do task with a Goal the method 500 may continue to step 506, and if the user 101 provides input indicating that they do want to associate the To-Do task with a Goal the method 500 may continue to step 505.

In step 505 the communication engine 131 may configure the GUI on the client device 400 of the user 101 to query the user 101 for and receive activity data which may include: what Goal to associate the To-Do task with; the title of the To-Do task; a description of the To-Do task; a start time, start date, due date, and/or other time data; and one or more notification times. The user 101 may then select to save the To-Do task and the communication engine 131 may then provide the data to a management engine 132, such as which may be running on a server 300, where it may be stored in a system database 120.

In step 506 the communication engine 131 may configure the GUI on the client device 400 of the user 101 to query the user 101 for and receive activity data which may include: the title of the To-Do task; a description of the To-Do task; a start time, start date, due date, and/or other time data; and one or more notification times. Optionally, the communication engine 131 or management engine 132 may automatically select Categories, such as Values, Vitality, Health, Growth, Career, and Finances, to associate the To-Do task with based on the data entered in step 506. The user 101 may then select to save the To-Do task and the communication engine 131 may then provide the data to a management engine 132, such as which may be running on a server 300, where it may be stored in a system database 120.

In step 507, the user 101 may input data indicating that they desire to view statistics of their one or more To-Do tasks. The communication engine 131 may configure the GUI to enable to user 101 to select how the statistics are displayed, such as by time frame, by category, etc.

In step 508, the user 101 may input data indicating that they desire to view statistics by time frame and the method 500 may proceed to step 509 in which the communication engine 131 may configure the GUI to enable to user 101 to select how the statistics are displayed, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week and optionally view To-Do tasks that are not related to or associated with a Goal. After step 509, the method may proceed to one of steps 502, 503, 507, 512, 508 and 510.

In step 510, the user 101 may input data indicating that they desire to view statistics by categories and the method 500 may proceed to step 511 in which the communication engine 131 may configure the GUI to enable to user 101 to select how the statistics are displayed in categories, such as: by the number of done or completed To-Do tasks; by number of pending To-Do tasks; and by number if overdue To-Do tasks. Preferably, To-Do tasks displayed to the user 101 in step 511 may be able to be edited, deleted, copied, have their status altered, or otherwise modified via user 101 input and the method may optionally proceed to step 504. After step 511, the method may proceed to one of steps 502, 503, 507, 512, 508 and 510.

In step 512, the user 101 may input data indicating that they desire to share data describing one or more To-Do tasks, such as in a message to one or more other users 101, and the method 500 may proceed to step 513 in which the communication engine 131 may configure the GUI to enable to user 101 to select which To-Do task data may be shared, preferably via a desired time frame, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week. In preferred embodiments of step 513, the user 101 may select to share Goal(s) and To-Do task(s) via system messaging capabilities. In yet further preferred embodiments of step 513, the user 101 may select to share detailed activities, such as in PDF or other formatted reports. In yet further preferred embodiments of step 513, the user 101 may select to share one or more screen captures generated on their client device 400. After step 513, the method 500 may proceed to one of steps 502, 503, 507, 512, or the method 500 may finish 514.

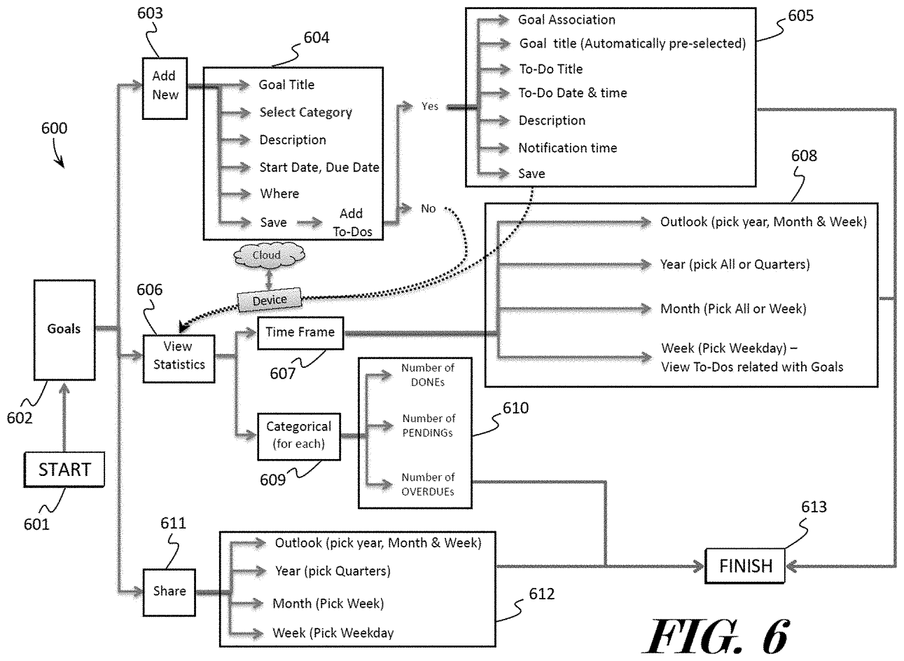

FIG. 6 shows a block diagram of an example of a computer-implemented time management method for managing Goals (“the method”) 600 according to various embodiments described herein. In some embodiments, the method 600 may be used to enable a user 101 to enter activity data into the system 100 which the system 100 may then generate one or more Goals and associate one or more To-Do tasks with those Goals which may be displayed to the user 101 via a GUI that may be generated on a client device 400 of the user 101 so that the user 101 can statistically and categorically visualize Goals from To-Do tasks. One or more steps of the method 600 may be performed by a communication engine 131 and/or a management engine 132 which may be executed by a computing device processor, such as a processor 302 (FIG. 2) and/or a processor 402 (FIG. 3).

In some embodiments, the method 600 may start 601 and a user 101 may interact with a GUI generated on their client device 400 by a communication engine 131 to provide input to the system 100 that indicates that the user 101 would like to access Goal data in step 602. The method 600 may then proceed to step 603, 606, or 611.

In step 603, the user 101 may provide input to the system 100 that indicates that the user 101 would like to add a new Goal, and the method 600 may proceed to step 604 in which the user 101 may input data describing the new Goal. In step 604, the communication engine 131 may configure the GUI on the client device 400 of the user 101 to query the user 101 for and receive Goal data which may include: the title of the Goal; a description of the Goal; a start time, start date, due date, and/or other time data; and location data of the Goal. Optionally, the communication engine 131 or management engine 132 may automatically select a Goal category, such as Values, Vitality, Health, Growth, Career, and Finances, based on the data entered in step 604. The user 101 may then select to save the Goal and the communication engine 131 may query the user 101 if they would like to add or associate one or more To-Do tasks with the Goal. If the user 101 would not like to add or associate one or more To-Do tasks with the Goal, the communication engine 131 may then provide the data to a management engine 132, such as which may be running on a server 300, where it may be stored in a system database 120 and the method 600 may proceed to step 606.

If the user 101 would like to add or associate one or more To-Do tasks with the Goal, the method 600 may proceed to step 605, and the communication engine 131 may configure the GUI on the client device 400 of the user 101 to query the user 101 for and receive Goal association data which may include: the title of the Goal (preferably automatically pre-selected for the new Goal created in step 604); the To-Do task title that is to be associated with the Goal; To-Do task date and time; a description of the To-Do task; and one or more notification times for the To-Do task. The user 101 may then select to save entered data and the communication engine 131 may then provide the data to a management engine 132, such as which may be running on a server 300, where it may be stored in a system database 120 and the method 600 may proceed to step 606.

In step 606, the user 101 may input data indicating that they desire to view statistics of their one or more Goals. The communication engine 131 may configure the GUI to enable to user 101 to select how the statistics are displayed, such as by time frame, by category, etc.

In step 607, the user 101 may input data indicating that they desire to view statistics by time frame and the method 600 may proceed to step 608 in which the communication engine 131 may configure the GUI to enable to user 101 to select how the statistics are displayed, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week and optionally view To-Do tasks that are not related to or associated with a Goal. After step 608, the method may proceed to one of steps 603, 606, 611, or the method 600 may finish 613.

In step 609, the user 101 may input data indicating that they desire to view statistics by categories and the method 600 may proceed to step 610 in which the communication engine 131 may configure the GUI to enable to user 101 to select how the statistics are displayed in categories, such as: by the number of done or completed Goals; by number of pending Goals; and by number if overdue Goals. Preferably, Goal displayed to the user 101 in step 610 may be able to be edited, deleted, copied, have their status altered, or otherwise modified via user 101 input and the method may optionally proceed to step 604. After step 610, the method may proceed to one of steps 603, 606, 611, or the method 600 may finish 613.

In step 611, the user 101 may input data indicating that they desire to share data describing one or more Goals, such as in a message to one or more other users 101, and the method 600 may proceed to step 612 in which the communication engine 131 may configure the GUI to enable to user 101 to select which Goal data may be shared, preferably via a desired time frame, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week. In preferred embodiments of step 612, the user 101 may select to share Goal(s) and To-Do task(s) via system messaging capabilities. In yet further preferred embodiments of step 612, the user 101 may select to share detailed activities, such as in PDF or other formatted reports. In yet further preferred embodiments of step 612, the user 101 may select to share one or more screen captures generated on their client device 400. After step 612, the method 600 may proceed to one of steps 603, 606, 611, or the method 600 may finish 613.

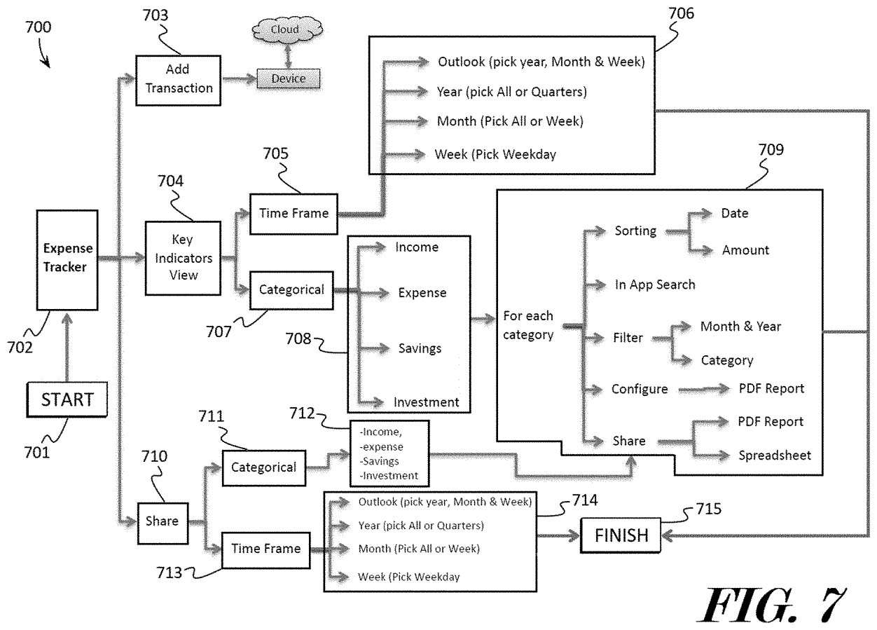

FIG. 7 shows a block diagram of an example of a computer-implemented time management method for managing financial data (“the method”) 700 according to various embodiments described herein. In some embodiments, the method 700 may be used to enable a user 101 to enter financial data into the system 100 which the system 100 may then generate one or more reports which may be displayed to the user 101 and generate one or more messages having desired financial data that may be sent to other users 101. One or more steps of the method 700 may be performed by a communication engine 131 and/or a management engine 132 which may be executed by a computing device processor, such as a processor 302 (FIG. 2) and/or a processor 402 (FIG. 3).

In some embodiments, the method 700 may start 701 and a user 101 may interact with a GUI generated on their client device 400 by a communication engine 131 to provide input to the system 100 that indicates that the user 101 would like to access financial data in step 702. The method 700 may then proceed to step 703, 704, or 710.

In step 703, the user 101 may provide input to the system 100 that indicates that the user 101 would like to add a new a new financial transaction, and the user 101 may input data describing the new financial transaction. The communication engine 131 may then provide the data to a management engine 132, such as which may be running on a server 300, where it may be stored in a system database 120.

In step 704, the user 101 may input data indicating that they desire to view key indicators of their one or more financial transactions which were created in step 703. The communication engine 131 may configure the GUI to enable to user 101 to select how the key indicators are displayed, such as by time frame, by category, etc.

In step 705, the user 101 may input data indicating that they desire to view statistics of their financial transactions by time frame and the method 700 may proceed to step 706 in which the communication engine 131 may configure the GUI to enable to user 101 to select how the statistics are displayed, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week. After step 706, the method 700 may proceed to one of steps 703, 704, 710, or the method 700 may finish 715.

In step 707, the user 101 may input data indicating that they desire to view key indicators of their financial transactions by categories and the method 700 may proceed to step 708 in which the communication engine 131 may configure the GUI to enable to user 101 to select how the financial transactions are displayed in categories, such as by: income type of financial transactions; expense type financial transactions; savings type financial transactions; and investment type financial transactions. For each category selected in step 708, the method 700 may proceed to step 709 in which the communication engine 131 may query the management engine 132 for the respective financial transaction data and then display the data according to user 101 selectable options that may include: sorting the financial transactions, such as by date or amount; allowing a search of the financial transactions, such as by an in-app search; filtering the financial transactions, such as by month, year, category, etc.; configuring the type of financial transactions that may populate a report, such as a PDF, spreadsheet, etc.; and sharing of the financial transactions with one or more other users 101 via messaging that may include a report, such as a PDF, spreadsheet, etc. After step 709, the method 700 may proceed to one of steps 703, 704, 710, or the method 700 may finish 715.

In step 710, the user 101 may input data indicating that they desire to share financial data of one or more of their financial transactions which were created in step 703. The communication engine 131 may configure the GUI to enable to user 101 to select how the financial data may be shared, such as by time frame, by category, etc.

In step 711, the user 101 may input data indicating that they desire to select financial data for sharing according to financial transaction categories and the method 700 may proceed to step 712 in which the communication engine 131 may configure the GUI to enable to user 101 to select how the financial transactions are displayed in categories, such as by: income type of financial transactions; expense type financial transactions; savings type financial transactions; and investment type financial transactions. For each category selected in step 712, the communication engine 131 may query the management engine 132 for the respective financial transaction data and then share of the financial transaction data with one or more other users 101 via messaging that may include a report, such as a PDF, spreadsheet, etc., such as described in step 709. Optionally, the method 700 may proceed to one of steps 703, 704, 710, or the method 700 may finish 715.

In step 713, the user 101 may input data indicating that they desire to select financial transaction data for sharing by time frame, and the method 700 may proceed to step 714 in which the communication engine 131 may configure the GUI to enable to user 101 to select financial transaction data for sharing, such as by: outlook, in which the user 101 may select a year; year, in which the user 101 may select one or more quarters, such as all quarters; month, in which the user 101 may select one or more weeks, such as all weeks; weeks, in which the user 101 may select one or more days of the week. In preferred embodiments of step 713, the user 101 may select to share the financial data via system messaging capabilities. In yet further preferred embodiments of step 713, the user 101 may select to share detailed activities of the financial data, such as in PDF or other formatted reports. In yet further preferred embodiments of step 713, the user 101 may select to share one or more screen captures generated on their client device 400. After step 714, the method 700 may proceed to one of steps 703, 704, 710, or the method 700 may finish 715.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or Wi-Fi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A time management system, the system comprising:
a client device having a display screen and an input interface for receiving input from a user; and
a computing platform having a processor, a memory in communication with the processor, and
communication logic stored in the memory, executed by the processor and configured to receive input from the user, wherein the input comprises activity data and financial data;
management logic stored in the memory, executed by the processor and configured to generate To-Do tasks and Goals using the activity data and configured to generate financial transactions using the financial data, wherein the To-Do tasks are categorized under Goals that may include: Values, Vitality, Health, Growth, Finance, Career and Relationships;
wherein input from the user is used query the communication engine to view, plan, and generate reports for the To-Do tasks and financial transactions on their client device; and
wherein input from the user is provided to the communication engine for the generation of one or more messages that are sent to client devices of one or more other users in which the message(s) include data describing one or more of a To-Do task, Goal, and financial transaction of the user.
